(19) United States
(12) Patent Application Publication
(10) Pub. No.: US 2011/0309840 A1
(43) Pub. Date: Dec. 22, 2011

(54) BATTERY ANOMALY DETERMINATION APPARATUS AND BATTERY ANOMALY WARNING APPARATUS

(75) Inventor: Akihiko YAMAGUCHI, Kariya-city (JP)

(73) Assignee: DENSO CORPORATION, Kariya-city (JP)

(21) Appl. No.: 13/161,632

(22) Filed: Jun. 16, 2011

(30) Foreign Application Priority Data
Jun. 21, 2010 (JP) 2010-140380

(51) Int. Cl. G01N 27/416; H02J 7/00

(52) U.S. Cl. 324/433; 320/132

(57) ABSTRACT

A memory stores information that stipulates a standard variable value of a battery residual quantity of a battery during an electric power supply in association with a consumed electric current. A battery anomaly determination apparatus specifies a standard variable value of the battery residual quantity corresponding to a total consumed electric current of loads connected with a battery mounted in a vehicle based on the information stored in the memory, and compares the specified standard variable value of the battery residual quantity with a detection value of the battery residual quantity of the battery mounted in the vehicle, thereby determining and warning an anomaly of the battery.

### CROSS REFERENCE TO RELATED APPLICATION

The present application is based on and incorporates herein by reference Japanese Patent Application No. 2010-140380 filed on Jun. 21, 2010.

### FIELD OF THE INVENTION

The present invention relates to a battery anomaly determination apparatus, which determines an anomaly of a battery which executes an electric power supply to a load in a vehicle, and a battery anomaly warning apparatus which warns of the anomaly of the battery.

### BACKGROUND OF THE INVENTION

[Patent document 1] JP-2007-274806 A (US-2009/0040033 A1))

There is known a vehicle such as a hybrid vehicle and an electric vehicle to travel using an electric motor as a driving source for traveling. When a battery residual quantity of a battery supplying an electric power to the motor falls, the battery is charged using an electric motor or charging apparatus, enabling the vehicle to continue traveling.

Such a vehicle is equipped with a meter display indicating a battery residual quantity. The user can recognize the battery residual quantity easily by looking at the meter display.

In addition, there is a battery information display apparatus for a hybrid vehicle to display information on battery life. In the battery information display apparatus, factors affecting a battery deterioration are studied based on environmental data on battery, power consumption data on electronic auto-part, and vehicle travel data containing driving manipulation data; an influence rate to an age-related deterioration with respect to each of the factors is calculated and accumulated as a degree of a battery deterioration. From the accumulated degree of the battery deterioration, the information on battery life is displayed (for example, refer to Patent document 1).

A long time use of a battery undergoes an age-related deterioration, lowering a charge possible capacity and shortening a life. The vehicle equipped with the meter display indicating a battery residual quantity enables a user to recognize a present battery residual quantity, but does not enable the user to recognize a battery anomaly due to the age-related deterioration.

In addition, the apparatus described in Patent document 1 calculates and accumulates as a degree of a battery deterioration an influence rate to the age-related deterioration which is classified with respect to each factor affecting the battery deterioration, estimating a useful life of the battery. Thus, the apparatus does not directly determine a normality or anomaly of the battery residual quantity; a determination and a warning of a battery anomaly may not be made with a sufficient accuracy, posing a problem.

### SUMMARY OF THE INVENTION

The present invention is made in view of the above problem. It is an object of the present invention to determine and warn of a battery anomaly with more sufficient accuracy.

To achieve the above object, according to a first example of the present invention, a battery anomaly determination apparatus to determine an anomaly of a battery mounted in a vehicle is provided as follows. A storage device is included to store a standard variable value of a battery residual quantity during an electric power supply to a load connected with the battery. A battery residual quantity detection section is included to detect a detection value of a battery residual quantity of the battery. A battery anomaly determination section is included to determine an anomaly of the battery by comparing the standard variable value of the battery residual quantity stored in the storage device with the detection value of the battery residual quantity detected by the battery residual quantity detection section.

Under such a configuration, an anomaly of a battery is determined by the comparison which is made, in respect of a battery residual quantity during an electric power supply to a load of the battery, between (i) a standard variable value previously stipulated and stored in a storage device and (ii) an actually detected present detection value. The determination of the battery anomaly is thus enabled with more sufficient accuracy.

According to a second example of the present invention, a battery anomaly determination apparatus to determine an anomaly of a battery mounted in a vehicle is provided as follows. A storage device is included to store a standard variable value of a battery residual quantity during an electric power supply to a load connected with the battery. A battery residual quantity detection section is included to detect a detection value of a battery residual quantity of the battery. A battery anomaly determination section is included to determine an anomaly of the battery by comparing a gradient of the standard variable value of the battery residual quantity stored in the storage device with a gradient of the detection value of the battery residual quantity detected by the battery residual quantity detection section.

Under such a configuration, an anomaly of a battery is determined by the comparison which is made, in respect of a battery residual quantity during an electric power supply to a load of the battery, between (i) a gradient of a standard variable value previously stipulated and stored in a storage device and (ii) a gradient of an actually detected present detection value. The determination of the battery anomaly is thus enabled with more sufficient accuracy.

As a yet another example of the present invention, a battery anomaly warning apparatus is provided as follows. The above mentioned battery anomaly determination apparatus of the first or second example is included and a warning section is included to warn of an anomaly of the battery when the battery anomaly determination apparatus determines that the battery has an anomaly.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram illustrating a configuration of a battery anomaly determination apparatus or a battery monitor module of an embodiment of the present invention;

FIG. 2 is a diagram for explaining a characteristic of a battery full charge quantity depending on age-related deterioration;

FIG. 3 is a diagram for explaining a standard variable value of a battery residual quantity over time during an electric power supply;

FIG. 4 is a flowchart illustrating a battery anomaly determination and warning process;

FIG. 5 is a diagram for explaining a determination of a battery anomaly; and

FIG. 6 is a diagram for explaining a second embodiment of the present invention.

### DETAILED DESCRIPTION OF THE PREFERRED EMBODIMENTS

### First Embodiment

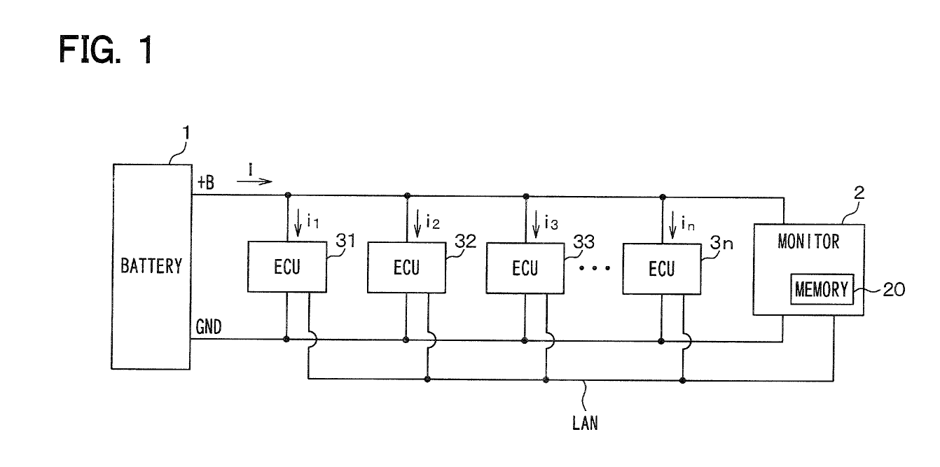

A configuration of a battery anomaly determination apparatus (also referred to as a battery anomaly warning apparatus) according to a first embodiment of the present invention is illustrated in FIG. 1. The present battery anomaly determination apparatus is provided as a battery monitor module 2 including a memory 20. In addition, the battery monitor module 2 is connected with a display portion and a speaker (none shown). The battery anomaly determination apparatus is to determine and warn of an anomaly of a battery 1 which executes an electric power supply (i.e., discharge) to a load which includes several ECUs 31 to 3n mounted in a subject vehicle.

The battery monitor module 2 includes a computer equipped with a CPU, I/O and in-vehicle LAN interface (none shown). The CPU executes various processes according to programs stored in the memory 20.

The battery monitor module 2 can communicate with each of ECUs 31 to 3n via an in-vehicle LAN connected to the in-vehicle LAN interface. In addition, each of the ECUs 31 to 3n is equipped with an electric current sensor (none shown) which detects an electric current consumed in each ECU itself.

The battery monitor module 2 can acquire information for specifying or detecting each consumed electric current from each of the ECUs 31 to 3n via the in-vehicle LAN interface.

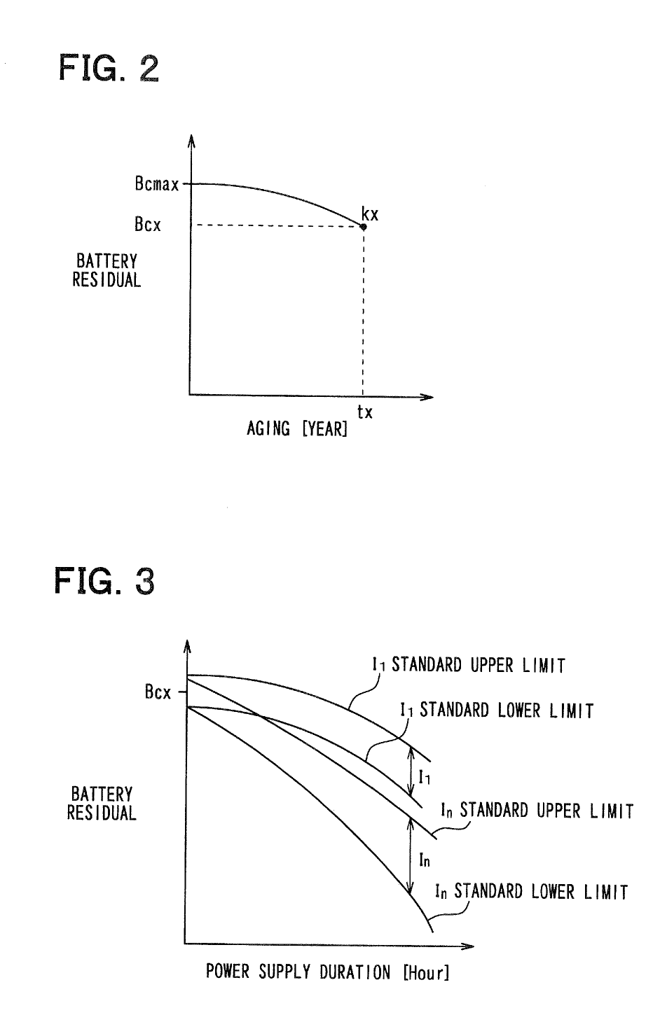

The repeated charge and discharge in the long time use of the battery exhibits a characteristic or tendency to gradually lower a battery residual quantity at the time of the full charge (i.e., a battery full charge quantity) depending on an age-related variation (i.e., an age-related deterioration). The characteristic of the battery full charge quantity due to the age-related deterioration is illustrated in FIG. 2. As illustrated, the battery full charge quantity falls due to an age-related deterioration.

Here, an age-related deterioration constant is Kx; a battery full charge quantity at the time of beginning the use of the battery 1 (e.g., at the time of being mounted in the vehicle) is Bcmax. The battery residual quantity Bcx at the full charge state at a time tx that is an elapsed time (e.g., elapsed years) since beginning the use of the battery 1 is expressed by an equation (Bcx=(Kx)×(Bcmax)). The age-related deterioration constant Kx is a real number greater than zero and no more than one. Such an age-related deterioration constant Kx is stipulated so as to set at one (1) at the time of beginning the use of the battery 1 and decrease gradually from one depending on a duration of the use (e.g., across the ages (months, years)) of the battery.

Further, a battery has a characteristic that repeated charge and discharge in a long time use of the battery undergoes an age-related variation, lowering a charge possible capacity and shortening a life. Thus, the fall in the charge possible capacity involves enhancing a reduction speed of the battery residual quantity even though the battery 1 is charged up to a predetermined reference value (for example, a full charge quantity). Enhancement in the reduction speed of the battery residual quantity may result in lowering the battery residual quantity to possibly disable the traveling of the vehicle before arriving at a destination.

The memory 20 of the battery monitor module 2 according to the present embodiment stores information of a standard variable value of the battery residual quantity, which is defined as follows. First, the battery 1 is charged up to a predetermined reference value (i.e., a full charge quantity); an electric power supply is started to each load 31 to 3n of the battery 1; this start time point is referred to as a reference start time. The standard variable value of the battery residual quantity of the normal battery during an electric power supply to each load from the reference start time is stipulated with respect to (i.e., in associated with) the total consumed electric current in all the loads 31 to 3n connected with the battery 1. The battery monitor module 2 determines a battery anomaly based on the stored information on standard variable value of the battery residual quantity. It is noted that the memory 20 further stores information for specifying a kind of battery mounted in a vehicle.

FIG. 3 illustrates a standard variable value of the battery residual quantity (upper limit standard variable value, and lower limit standard variable value). It is noted that the drawing indicates a relation or association between (i) battery residual quantities under a consumed electric current I1 and under a consumed electric current and (ii) a power supply duration (i.e., hour(s)). The consumed electric current I1 and the consumed electric current In have a relation of I1<In satisfied.

As illustrated, a standard variable value of the battery residual quantity (upper limit standard variable value, and lower limit standard variable value) is stipulated so as to decrease gradually in connection with an elapse or course of the electric power supply duration or time to each load 31 to 3n of the battery 1. In addition, the reduction speed of the battery residual quantity changes also depending on the consumed electric current applied to a load connected to a battery.

The battery monitor module 2 specifies a standard variable value of the battery residual quantity corresponding to the present consumed electric current based on the information stored in the memory 20, and compares with each other (i) the standard variable value within a normal fluctuant range (also referred to as an allowable range) of the battery residual quantity in associated with a power supply duration or time and (ii) a present variable value (i.e., presently detected detection value) of the battery residual quantity of the battery 1, thereby executing a battery anomaly determination and warning process to determine and warn of an anomaly of the battery 1.

In the present embodiment, the standard variable value of the battery residual quantity is stipulated with respect to each of kinds of batteries. The battery monitor module 2 reads out from the memory 20 the information applicable to the kind of battery mounted in the vehicle, and compares with each other (i) the standard variable value of the battery residual quantity corresponding to the kind of the battery 1 mounted in the vehicle and (ii) a variable value (i.e., a detection value) of the battery residual quantity of the present battery 1, thereby determining an anomaly of the battery 1.

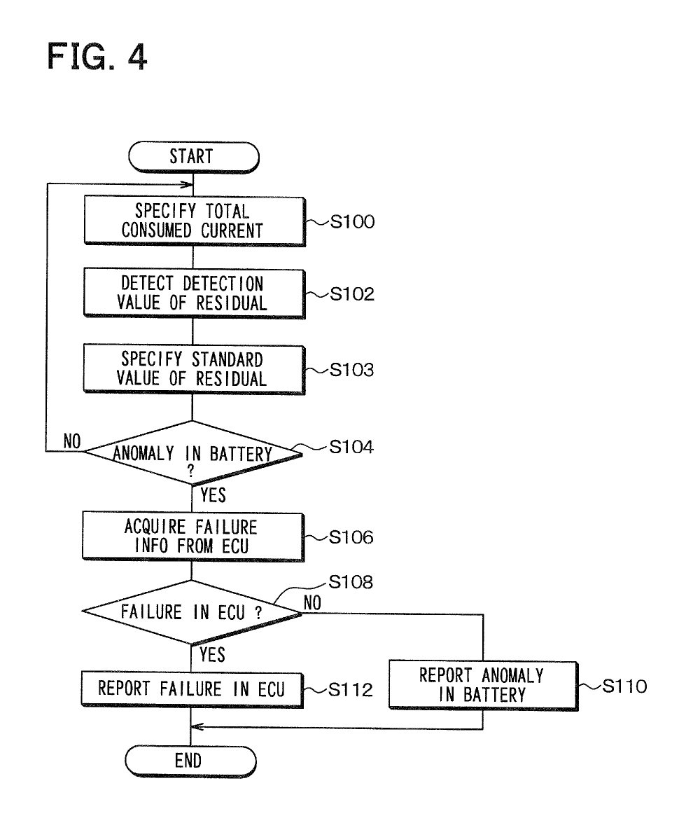

The following will explain a battery anomaly determination and warning process with reference to FIG. 4. It is further noted that a flowchart or the processing of the flowchart in the present application includes sections (also referred to as steps), which are represented, for instance, as S100. Further, each section can be divided into several sub-sections while several sections can be combined into a single section. Furthermore, each of thus configured sections can be referred to as a means or module and achieved not only as a software device but also as a hardware device. First, a total consumed electric current at the present time is specified (S100). In specific, the information is acquired which specifies each consumed electric current from each of the ECUs 31 to 3n via the in-vehicle LAN connected to the vehicle LAN interface. From the information for specifying the consumed electric current of each of the loads 31 to 3n, the total consumed electric current of the ECUs 31 to 3n connected with the battery 1 is calculated. The total consumed electric current of the loads 31 to 3n connected with the battery 1 is calculated as a total sum of the respective consumed electric currents of the ECUs 31 to 3n. When an electric current which flows into each of the loads 31 to 3n is expressed by I1 to In, the total consumed electric current is expressed as (I1+I2+ . . . +In).

Next, the variable value (i.e., detection value) of the battery residual quantity is specified or detected (S102). In specific, the variable value or detection value of the battery residual quantity is specified or detected by collecting records or histories of the battery residual quantity for fixed time intervals. In the present embodiment, first, the battery residual quantity is charged up to a predetermined reference value (e.g., the full charge quantity); then, from the start of the electric power supply to the loads 31 to 3n of the battery 1, the variable value or detection value of the battery residual quantity is specified or detected. That is, the strat of the electric power supply serves as a reference start time.

Next, the standard variable value of the battery residual quantity corresponding to the present consumed electric current is specified (S103). Then, an anomaly of the battery 1 is determined (S104). That is, first, the information applicable to the kind of the battery 1 mounted in the subject vehicle is read out from the memory 20. Based on the read information applicable to the kind of the battery 1 mounted in the subject vehicle, the standard variable value (upper limit standard variable value and lower limit standard variable value) of the battery residual quantity corresponding to the present total consumed electric current In is specified (S103). The standard variable value (upper limit standard variable value and lower limit standard variable value) of the battery residual quantity specified at S103 is compared with the variable value or detection value of the battery residual quantity specified or detected at S102; the anomaly of the battery is then determined at S104. It is noted that the standard variable value of the battery residual quantity is amended at S103 by multiplying the standard variable value of the battery residual quantity by the age-related deterioration constant Kx, which is associated with or corresponds to the elapsed time (e.g., duration across the ages) from a manufacturing date of the battery 1. For example, suppose the case where the battery residual quantity is charged up to the predetermined reference value (e.g., the full charge quantity), and three hours then have passed since the start of the electric power supply to the loads 31-3n of the battery. In such a case, so as to determine an anomaly of the battery 1, the following two are compared with each other. The first is a value obtained or specified at S103 from multiplying the age-related deterioration constant Kx by the standard variable value (upper limit standard variable value and lower limit standard variable value) of the battery residual quantity in the state when three hours have passed since the reference start time of the electric power supply; the second is an actual variable value (i.e., detection value) of the battery residual quantity specified or detected at S102 in the state when three hours have passed since the start of the electric power supply to the loads 31 to 3n of the battery 1.

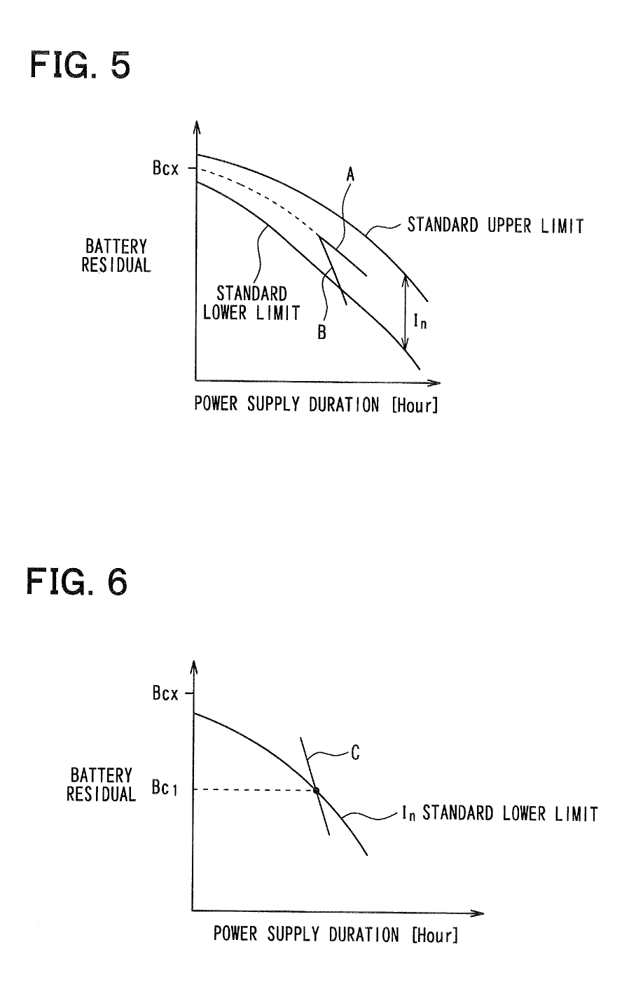

As illustrated in A of FIG. 5, when the variable value or detection value of the battery residual quantity specified or detected at S102 is within an allowable range of the standard variable value (i.e., between the standard upper limit variable value and the standard lower limit variable value) of the battery residual quantity, namely, when the present detection value of the battery residual quantity detected at S102 is no less than the standard lower limit variable value of the battery residual quantity, and less than the standard upper limit variable value of the battery residual quantity specified at S103, the determination at S104 is affirmed and the processing returns to S100.

In addition, as illustrated in B of FIG. 5, when the detection value of the battery residual quantity detected at S102 falls due to the deterioration of the battery 1 less than the standard lower limit variable value of the battery residual quantity, and is not included in (or not compliant with) the standard variable value of the battery residual quantity specified at S103, the determination at S104 is negated as NO. Subsequently, failure information is obtained from each ECU 31 to 3n via the in-vehicle LAN (S106).

In addition, because of a failure of the loads 31 to 3n or the like, the detection value of the battery residual quantity detected at S102 may turn into more than the standard upper limit variable value of the battery residual quantity specified at S103, and be not included in the standard variable value of the battery residual quantity. In such a case, the determination at S104 is negated as NO. Subsequently, failure information is obtained from each ECU 31 to 3n via the in-vehicle LAN (S106).

Next, a failure determination is executed based on whether failure information is acquired from each ECU 31 to 3n (S108). When the failure information is not acquired from each ECU 31 to 3n, either, the determination at S108 is negated as NO, a battery anomaly is determined and then warned (S110). In specific, a display portion (unshown) is caused to display a message which indicates an anomaly in the variable value or detection value of the battery residual quantity of the battery 1 while a speaker (unshown) is caused to sound information indicating the message. The present process is then ended.

When the failure information is acquired from each ECU 31 to 3n, the determination at S108 is affirmed. In specific, a display portion (unshown) is caused to display a message which indicates an anomaly in the ECU where the anomaly information is acquired while a speaker (unshown) is caused to sound output. The present process is then ended.

According to the above-mentioned configuration of the present embodiment, the following takes place. Information stipulates a standard variable value of a battery residual quantity during an electric power supply to a load of a battery in associated with a consumed electric current of a load connected to the battery. Based on such information, the standard variable value of the battery residual quantity corresponding to the consumed electric current in the load connected with the battery 1 mounted in the subject vehicle is specified. The comparison is then made between (i) the above specified standard variable value of the battery residual quantity and (ii) a detected detection value of the battery residual quantity of the battery 1. Thereby an anomaly of the battery 1 is determined. When it is determined that the battery 1 has an anomaly, the anomaly of the battery 1 is warned of, enabling warning of the battery anomaly with more sufficient accuracy.

In addition, the information which stipulates the standard variable value of the battery residual quantity of the battery is stored in association with a kind of battery in a memory or storage device. Such information applicable to the kind of the battery 1 carried in the subject vehicle is read out from the storage device to be compared with the detection value of the battery residual quantity, enabling an easy response even in the case where the kind of a battery mounted in the vehicle is different. In addition, it can also respond to various types of vehicles easily.

### Second Embodiment

A configuration of a battery anomaly determination apparatus (also referred to a battery anomaly warning apparatus) according to a second embodiment of the present invention is identical to that illustrated in FIG. 1. As explained above, according to the first embodiment, the following is provided. Information stipulates a standard variable value of a battery residual quantity during an electric power supply to a load of a battery in associated with a consumed electric current of the load connected to a battery. Based on such information, the standard variable value of the battery residual quantity corresponding to the electric current consumed in the loads 31 to 3n connected with the battery 1 is specified. The comparison is then made between (i) the specified standard variable value of the battery residual quantity and (ii) a detection value of the battery residual quantity of the battery. Thereby an anomaly of the battery is determined. In contrast, according to the second embodiment, the following takes place. First, similarly, information stipulates a standard variable value of a battery residual quantity during an electric power supply to a load of a battery in associated with a consumed electric current of a load connected to a battery. Based on such information, the standard variable value of the battery residual quantity corresponding to the consumed electric current specified by a consumed electric current specifying means is then specified. The comparison is then made between (i) a gradient of the standard variable value of the battery residual quantity and (ii) a gradient of a detection value of the battery residual quantity of the battery 1 detected by a battery residual quantity detection means. Thereby an anomaly of the battery is determined.

According to the second embodiment, the battery monitor module 2 includes a memory 20 storing information that stipulates, in association with a consumed electric current of a load connected with a battery, a standard lower limit variable value of a battery residual quantity during an electric power supply to the load connected to the battery. The standard lower limit variable value of the battery residual quantity in the consumed electric current In is illustrated in FIG. 6.

The battery monitor module 2 specifies, based on the stored information, a standard variable value of the battery residual quantity corresponding to a consumed electric current of the loads 31 to 3n connected with the battery 1, and compares (i) a gradient of the specified standard variable value of the battery residual quantity and (ii) a gradient of a detection value of the battery residual quantity of the battery 1 detected by the battery residual quantity detection means. Thereby an anomaly of the battery 1 is determined.

In specific, as shown in FIG. 6, a gradient of the detection value at the present battery residual quantity Bc1 is compared with a gradient of the standard lower limit variable value at the battery residual quantity Bc1. When the gradient of the detection value at the present battery residual quantity Bc1 is greater, it is determined that the battery 1 is normal. When the gradient of the detection value at the present battery residual quantity Bc1 is smaller, it is determined that the battery 1 has an anomaly, as illustrated in C of FIG. 6.

Under such a configuration, information stipulates a standard variable value of a battery residual quantity during an electric power supply to a load of a battery in association with a consumed electric current of a load connected to a battery (i.e., a normal battery). Based on such information, the standard variable value of the battery residual quantity corresponding to the electric current consumed in the load connected with the battery 1 is specified. The comparison is then made between (i) the gradient of the specified standard variable value of the battery residual quantity and (ii) the gradient of the detection value of the battery residual quantity of the battery 1. Thereby an anomaly of the battery 1 is determined. When it is determined that the battery 1 has an anomaly or is abnormal, a battery anomaly is warned of, enabling warning of the battery anomaly with more sufficient accuracy.

Further, as explained above, the comparison is made between (i) the gradient of the standard variable value of the battery residual quantity and (ii) the gradient of the detection value of the battery residual quantity of the battery 1, thereby determining an anomaly of the battery 1. The determination of an anomaly can be thus executed even if the battery is not charged up to the predetermined reference value (for example, the full charge quantity).

### Other Embodiments

In the above first embodiment, both the standard upper limit variable value and the standard lower limit variable value of the battery residual quantity are stipulated. Without need to be limited thereto, for example, only the standard lower limit variable value of the battery residual quantity may be stipulated.

Further, in the above first embodiment, the reference start time of the battery residual quantity in the information stored in the memory 20 of the battery monitor module 2 is corresponded to by the start time of the electric power supply to each load 31 to 3n after the battery residual quantity of the battery is charged up to the predetermined reference value (e.g., full charge quantity). That is, Information stipulates a standard variable value (i.e., the standard upper limit variable value and the standard lower limit variable value) of a battery residual quantity during an electric power supply to a load of a battery in association with a total consumed electric current of a load connected to a battery as a basis of a reference start time that is the start time of the electric power supply after the battery is charged up to the predetermined battery residual quantity (e.g., full charge quantity). The above is only an example. For instance, the standard variable value of the battery residual quantity may be stipulated on another basis of a reference start time other than the above-mentioned the start time of the electric power supply.

Further, in the above first embodiment, at S103, the standard variable value (or the standard upper limit variable value and/or the standard lower limit variable value) of the battery residual quantity is lowered or reduced according to the elapsed time (across the ages, resulting in an age-related deterioration) from the manufacturing date of the battery 1. The comparison is then made between (i) the standard variable value of the battery residual quantity that is lower as the above and (ii) the detection value of the battery residual quantity of the battery 1 detected by the battery residual quantity detection means. Thereby an anomaly of the battery is determined. Without need to be limited thereto, for example, according to the accumulation of the total travel time under the state where the battery 1 is mounted in the subject vehicle, the standard variable value of the battery residual quantity may be reduced. The comparison may be then made between (i) the standard variable value of the battery residual quantity that is reduced according to the total travel time and (ii) the detection value of the battery residual quantity of the battery detected by the battery residual quantity detection means. Thereby an anomaly of the battery may be determined.

In addition, in the above first embodiment, at S103, the standard variable value of the battery residual quantity over time is lowered according to the elapsed time (across the ages, resulting in an age-related deterioration) from the manufacturing date of the battery 1. The comparison is then made between (i) the standard variable value of the battery residual quantity that is lowered according to the elapsed time and (ii) the detection value of the battery residual quantity of the battery 1 detected by the battery residual quantity detection means. Thereby an anomaly of the battery is determined. Without need to be limited thereto, for example, according to the accumulation of the total travel distance under the state where the battery 1 is mounted in the subject vehicle, the standard variable value of the battery residual quantity may be reduced. The comparison may be then made between (i) the standard variable value of the battery residual quantity that is reduced according to the total travel distance and (ii) the detection value of the battery residual quantity of the battery 1 detected by the battery residual quantity detection means. Thereby an anomaly of the battery may be determined.

Further, in the above embodiments, the information for specifying the consumed electric current is acquired from each load via the in-vehicle LAN, and the total consumed electric current of the loads connected to the battery is calculated. Without need to be limited to such a technology, another technology may be used for specifying the consumed electric current of each load connected to the battery.

The battery monitor module 2 may function as a consumed current specification section or means at S406 in FIG. 4, a battery residual quantity detection section or means at S102 in FIG. 4, a battery anomaly determination section or means at S103 and S104 in FIG. 4, and a warning section or means at S110 in FIG. 4. Further, S103 alone in FIG. 4 may be executed by a standard residual quantity specification section or means of the battery monitor module 2.

Furthermore, the software section or unit or any combinations of multiple software sections or units can be included in a software program, which can be contained in a non-transitory computer-readable storage media or can be downloaded via a communications network and then stored in a non-transitory computer-readable storage media.

Aspects of the disclosure described herein are set out in the following clauses.

As an aspect of the disclosure, a battery anomaly determination apparatus to determine an anomaly of a battery mounted in a vehicle is provided as follows. A storage device is included to store a standard variable value of a battery residual quantity during an electric power supply to a load connected with the battery. A battery residual quantity detection section is included to detect a detection value of a battery residual quantity of the battery. A battery anomaly determination section is included to determine an anomaly of the battery by comparing the standard variable value of the battery residual quantity stored in the storage device with the detection value of the battery residual quantity detected by the battery residual quantity detection section.

As another aspect of the disclosure, a battery anomaly determination apparatus to determine an anomaly of a battery mounted in a vehicle is provided as follows. A storage device is included to store a standard variable value of a battery residual quantity during an electric power supply to a load connected with the battery. A battery residual quantity detection section is included to detect a detection value of a battery residual quantity of the battery. A battery anomaly determination section is included to determine an anomaly of the battery by comparing a gradient of the standard variable value of the battery residual quantity stored in the storage device with a gradient of the detection value of the battery residual quantity detected by the battery residual quantity detection section.

As an optional aspect of the disclosure, the battery anomaly determination apparatus may further includes a consumed current specification section configured to specify a consumed electric current that is consumed in the load connected with the battery. Herein, the storage device may store the standard variable value of the battery residual quantity as information, which stipulates the standard variable value in association with a consumed electric current in the load connected with the battery. The battery anomaly determination section may specify the standard variable value of the battery residual quantity corresponding to the consumed electric current specified by the consumed current specification section, based on the information stored in the storage device. The battery anomaly determination section may determine an anomaly of the battery by using the specified standard variable value of the battery residual quantity, which corresponds to the consumed electric current specified by the consumed current specification section in addition to the detection value of the battery residual quantity detected by the battery residual quantity detection section.

As an optional aspect of the disclosure, in the battery anomaly determination apparatus, the standard variable value of the battery residual quantity may include a standard lower limit variable value of the battery residual quantity. Otherwise, the standard variable value of the battery residual quantity may include a standard lower limit variable value of the battery residual quantity and a standard upper limit variable value of the battery residual quantity.

As an optional aspect of the disclosure, in the battery anomaly determination apparatus: the storage device may store the standard variable value of the battery residual quantity as information, which stipulates the standard variable value in association with a kind of battery; and the determination section may read the standard variable value corresponding to a kind of the battery mounted in the vehicle, comparing the read standard variable value of the battery residual quantity with the detection value detected by the battery residual quantity detection section.

Such a configuration enables an easy response even in the case where the kind of the battery mounted in the vehicle is different. In addition, it can also practically respond to various types of vehicles easily.

As an optional aspect of the disclosure, in the battery anomaly determination apparatus, the standard variable value of the battery residual quantity of the battery may be stipulated to decrease gradually in connection with an elapsed time of the electric power supply to the load connected with the battery.

As an optional aspect of the disclosure, in the battery anomaly determination apparatus: the standard variable value of the battery residual quantity may be stipulated on a basis of a start time of an electric power supply to a load connected with the battery, the start time beginning after the battery residual quantity of the battery is charged to a predetermined reference value; and the battery residual quantity detection section may detect a detection value of the battery residual quantity of the battery on a basis of a start time of an electric power supply to the load connected with the battery, the start time beginning after the battery residual quantity of the battery is charged to a predetermined reference value.

In other words, the battery is charged up to a full charge quantity serving as a predetermined reference value; from the full charge quantity or state, a discharge of the battery is started. Such a start of the discharge is defined as a reference start time for specifying or detecting a present detection value of the battery residual quantity.

As an optional aspect of the disclosure, in the battery anomaly determination apparatus: the battery anomaly determination section may reduce the standard variable value of the residual quantity according to an age of the battery; and the battery anomaly determination section may compare the standard variable value of the battery residual quantity, which is reduced according to the age of the battery, with the detection value of the battery residual quantity detected by the battery residual quantity detection section.

Thus, an anomaly determination of the battery can be made in consideration of a deterioration across the ages (i.e., an age-related deterioration).

As an optional aspect of the disclosure, in the battery anomaly determination apparatus: the battery anomaly determination section may reduce the standard variable value of the residual quantity in association with a passage of a travel time of the vehicle under a state where the battery is mounted in the vehicle; and the battery anomaly determination section may compare the standard variable value of the battery residual quantity, which is reduced in association with the passage of the travel time of the vehicle, with the detection value of the battery residual quantity detected by the battery residual quantity detection section.

For instance, if comparing, with respect to a predetermined period (e.g., one year), a vehicle with a longer travel time with a vehicle with a shorter travel time, the vehicle with the longer travel time undergoes age-related deterioration more than the vehicle with the shorter travel time does. Thus, under the above configuration, an anomaly determination of the battery can be made in consideration of a deterioration across the ages (i.e., an age-related deterioration) due to the travel time of the vehicle carrying the relevant battery.

As an optional aspect of the disclosure, in the battery anomaly determination apparatus: the battery anomaly determination section may reduce the standard variable value of the residual quantity in association with an accumulation of a travel distance of the vehicle under a state where the battery is mounted in the vehicle; and the battery anomaly determination section may compare the standard variable value of the battery residual quantity, which is reduced in association with the accumulation of the travel distance, with the detection value of the battery residual quantity detected by the battery residual quantity detection section.

For instance, if comparing, with respect to a predetermined period (e.g., one year), a vehicle with a longer travel distance with a vehicle with a shorter travel distance, the vehicle with the longer travel distance undergoes age-related deterioration more than the vehicle with the shorter travel distance does. Thus, under the above configuration, an anomaly determination of the battery can be made in consideration of a deterioration across the ages (i.e., an age-related deterioration) due to the travel distance of the vehicle carrying the relevant battery.

As a yet another aspect of the disclosure, a battery anomaly warning apparatus is provided as follows. The above mentioned battery anomaly determination apparatus is included and a warning section is included to warn of an anomaly of the battery when the battery anomaly determination apparatus determines that the battery has an anomaly.

It will be obvious to those skilled in the art that various changes may be made in the above-described embodiments of the present invention. However, the scope of the present invention should be determined by the following claims.

What is claimed:

1. A battery anomaly determination apparatus to determine an anomaly of a battery mounted in a vehicle,
the battery anomaly determination apparatus comprising:
a storage device that stores a standard variable value of a battery residual quantity during an electric power supply to a load connected with the battery;
a battery residual quantity detection section configured to detect a detection value of a battery residual quantity of the battery; and
a battery anomaly determination section configured to determine an anomaly of the battery by comparing the standard variable value of the battery residual quantity stored in the storage device with the detection value of the battery residual quantity detected by the battery residual quantity detection section.

2. The battery anomaly determination apparatus according to claim 1, further comprising:
a consumed current specification section configured to specify a consumed electric current that is consumed in the load connected with the battery,
wherein:
the storage device stores the standard variable value of the battery residual quantity as information, which stipulates the standard variable value in association with a consumed electric current in the load connected with the battery;
the battery anomaly determination section specifies the standard variable value of the battery residual quantity corresponding to the consumed electric current specified by the consumed current specification section, based on the information stored in the storage device; and
the battery anomaly determination section determines an anomaly of the battery by comparing the specified standard variable value of the battery residual quantity corresponding to the consumed electric current specified by the consumed current specification section with the detection value of the battery residual quantity detected by the battery residual quantity detection section.

3. The battery anomaly determination apparatus according to claim 1, wherein
the standard variable value of the battery residual quantity includes a standard lower limit variable value of the battery residual quantity.

4. The battery anomaly determination apparatus according to claim 1, wherein
the standard variable value of the battery residual quantity includes a standard lower limit variable value of the battery residual quantity and a standard upper limit variable value of the battery residual quantity.

5. The battery anomaly determination apparatus according to claim 1, wherein:
the storage device stores the standard variable value of the battery residual quantity as information, which stipulates the standard variable value in association with a kind of battery; and
the determination section reads the standard variable value corresponding to a kind of the battery mounted in the vehicle, comparing the read standard variable value of the battery residual quantity with the detection value detected by the battery residual quantity detection section.

6. The battery anomaly determination apparatus according to claim 1, wherein
the standard variable value of the battery residual quantity of the battery is stipulated to decrease gradually in connection with an elapsed time of the electric power supply to the load connected with the battery.

7. The battery anomaly determination apparatus according to claim 1, wherein:
the standard variable value of the battery residual quantity is stipulated on a basis of a start time of an electric power supply to a load connected with the battery, the start time beginning after the battery residual quantity of the battery is charged to a predetermined reference value; and
the battery residual quantity detection section detects a detection value of the battery residual quantity of the battery on a basis of a start time of an electric power supply to the load connected with the battery, the start time beginning after the battery residual quantity of the battery is charged to a predetermined reference value.

8. The battery anomaly determination apparatus according to claim 1, wherein:
the battery anomaly determination section reduces the standard variable value of the residual quantity according to an age of the battery; and
the battery anomaly determination section compares the standard variable value of the battery residual quantity, which is reduced according to the age of the battery, with the detection value of the battery residual quantity detected by the battery residual quantity detection section.

9. The battery anomaly determination apparatus according to claim 1, wherein:
the battery anomaly determination section reduces the standard variable value of the residual quantity in association with a passage of a travel time of the vehicle under a state where the battery is mounted in the vehicle; and
the battery anomaly determination section compares the standard variable value of the battery residual quantity, which is reduced in association with the passage of the travel time of the vehicle, with the detection value of the battery residual quantity detected by the battery residual quantity detection section.

10. The battery anomaly determination apparatus according to claim 1, wherein:
the battery anomaly determination section reduces the standard variable value of the residual quantity in association with an accumulation of a travel distance of the vehicle under a state where the battery is mounted in the vehicle; and
the battery anomaly determination section compares the standard variable value of the battery residual quantity, which is reduced in association with the accumulation of the travel distance, with the detection value of the battery residual quantity detected by the battery residual quantity detection section.

11. A battery anomaly warning apparatus, comprising:
the battery anomaly determination apparatus according to claim 1; and
a warning section configured to warn of an anomaly of the battery when the battery anomaly determination apparatus determines that the battery has an anomaly.

12. A battery anomaly determination apparatus to determine an anomaly of a battery mounted in a vehicle,
the battery anomaly determination apparatus comprising:
a storage device that stores a standard variable value of a battery residual quantity during an electric power supply to a load connected with the battery;
a battery residual quantity detection section configured to detect a detection value of a battery residual quantity of the battery; and
a battery anomaly determination section configured to determine an anomaly of the battery by comparing a gradient of the standard variable value of the battery residual quantity stored in the storage device with a gradient of the detection value of the battery residual quantity detected by the battery residual quantity detection section.

13. The battery anomaly determination apparatus according to claim 12, further comprising:
a consumed current specification section configured to specify a consumed electric current that is consumed in a load connected to the battery,
wherein:
the storage device stores the standard variable value of the battery residual quantity as information, which stipulates the standard variable value in association with a consumed electric current in the load connected with the battery;
the battery anomaly determination section specifies the standard variable value of the battery residual quantity corresponding to the consumed electric current specified by the consumed current specification section, based on the information stored in the storage device; and
the battery anomaly determination section determines an anomaly of the battery by comparing a gradient of the specified standard variable value of the battery residual quantity corresponding to the consumed electric current specified by the consumed current specification section with a gradient of the detection value of the battery residual quantity detected by the battery residual quantity detection section.

14. The battery anomaly determination apparatus according to claim 12, wherein
the standard variable value of the battery residual quantity includes a standard lower limit variable value of the battery residual quantity.

15. The battery anomaly determination apparatus according to claim 12, wherein:
the storage device stores the standard variable value of the battery residual quantity as information, which stipulates the standard variable value in association with a kind of battery; and
the determination section reads the standard variable value corresponding to a kind of the battery mounted in the vehicle, comparing the read standard variable value of the battery residual quantity with the detection value detected by the battery residual quantity detection section.

16. The battery anomaly determination apparatus according to claim 12, wherein
the standard variable value of the battery residual quantity of the battery is stipulated to decrease gradually in connection with an elapsed time of the electric power supply to the load connected with the battery.

17. The battery anomaly determination apparatus according to claim 12, wherein:
the standard variable value of the battery residual quantity is stipulated on a basis of a start time of an electric power supply to a load connected with the battery, the start time beginning after the battery residual quantity of the battery is charged to a predetermined reference value; and
the battery residual quantity detection section detects a detection value of the battery residual quantity of the battery on a basis of a start time of an electric power supply to the load connected with the battery, the start time beginning after the battery residual quantity of the battery is charged to a predetermined reference value.

18. The battery anomaly determination apparatus according to claim 12, wherein:
the battery anomaly determination section reduces the standard variable value of the residual quantity according to an age of the battery; and
the battery anomaly determination section compares the standard variable value of the battery residual quantity, which is reduced according to the age of the battery, with the detection value of the battery residual quantity detected by the battery residual quantity detection section.

19. The battery anomaly determination apparatus according to claim 12, wherein:
the battery anomaly determination section reduces the standard variable value of the residual quantity in association with a passage of a travel time of the vehicle under a state where the battery is mounted in the vehicle; and
the battery anomaly determination section compares the standard variable value of the battery residual quantity, which is reduced in association with the passage of the travel time of the vehicle, with the detection value of the battery residual quantity detected by the battery residual quantity detection section.

20. The battery anomaly determination apparatus according to claim 1, wherein:
the battery anomaly determination section reduces the standard variable value of the residual quantity in association with an accumulation of a travel distance of the vehicle under a state where the battery is mounted in the vehicle; and
the battery anomaly determination section compares the standard variable value of the battery residual quantity, which is reduced in association with the accumulation of the travel distance, with the detection value of the battery residual quantity detected by the battery residual quantity detection section.

21. A battery anomaly warning apparatus, comprising:
the battery anomaly determination apparatus according to claim 12; and
a warning section configured to warn of an anomaly of the battery when the battery anomaly determination apparatus determines that the battery has an anomaly.
